(19) United States
(12) Patent Application Publication
(10) Pub. No.: US 2008/0085113 A1
(43) Pub. Date: Apr. 10, 2008

(54) SHUTTER AND IMAGING SYSTEM EMPLOYING SAME

(75) Inventor: BOR-YUAN HSIAO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/618,016

(22) Filed: Dec. 29, 2006

(30) Foreign Application Priority Data
Oct. 9, 2006 (CN) 200610200967.X

(51) Int. Cl. G02F 1/00

(52) U.S. Cl. 396/457

(57) ABSTRACT

An exemplary shutter includes an upper plate, a lower plate facing the upper plate, a side plate, a magnetic fluid, and a magnetic field generator. The side plate is connected between the upper plate and the lower plate. The upper plate, the lower plate, and the side plate cooperatively define a chamber. The magnetic fluid is accommodated in the chamber and includes a transparent solution, a surfactant, and a plurality of black magnetic particles dispersed in the solution and surrounded by the surfactant. Each of the particles is surrounded by a surfactant. The magnetic field generator is positioned outside and adjacent to the chamber, and is for generating a magnetic field in the chamber.

### BACKGROUND

1. Technical Field

The present invention relates generally to the optical imaging field and, more particularly to a shutter and an imaging system employing the same.

2. Description of Related Art

A shutter is a device that allows light to pass for a determined period of time, for the purpose of exposing photographic film or a light-sensitive electronic sensor to the right amount of light to create a permanent image of a view.

A typical imaging system adopts a mechanical shutter, which uses a relatively complex arrangement of springs, cams and gears. The mechanical shutter is complex, expensive, and noisy.

It is therefore desirable to find a new shutter and a new imaging system, which can overcome the above mentioned problems.

### SUMMARY

In a preferred embodiment, a shutter includes an upper plate, a lower plate facing the upper plate, a side plate, a magnetic fluid, and a magnetic field generator. The side plate is connected between the upper plate and the lower plate. The upper plate, the lower plate, and the side plate cooperatively define a chamber. The magnetic fluid is accommodated in the chamber and includes a transparent solution, a surfactant, and a plurality of black magnetic particles dispersed in the solution and surrounded by the surfactant. Each of the particles is surrounded by surfactant. The magnetic field generator is positioned outside and adjacent to the chamber, and is for generating a magnetic field in the chamber.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of an imaging system in a first state according to a preferred embodiment;

FIG. 2 is an enlarged, cross-sectional view of a shutter of the imaging system of FIG. 1 according to a first embodiment;

FIG. 3 is a schematic, cross-sectional view of the imaging system in a second state according to the preferred embodiment; and

FIG. 4 is an enlarged, cross-sectional view of a shutter according to a second embodiment.

### DETAILED DESCRIPTION OF THE EMBODIMENTS

Embodiments will now be described in detail below with reference to the drawings.

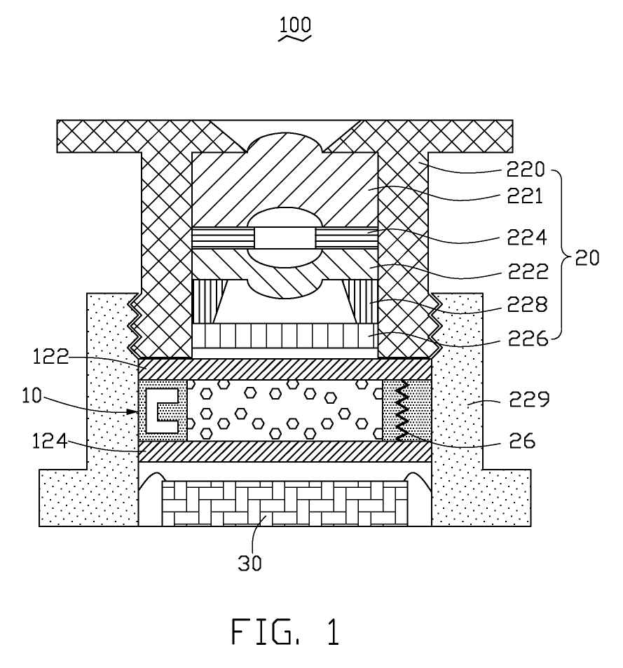

Referring to FIG. 1, an imaging system 100 according to a preferred embodiment is shown. The imaging system 100 includes a holder 229, an image sensor 30, a shutter 10, and a barrel unit 20. The image sensor 30 and the shutter 10 are received in the holder 229 in this order from an image side to an object side. The shutter 10 is positioned between the barrel unit 20 and the image sensor 30.

The barrel unit 20 includes a barrel 220, lenses 221 and 222, aperture plates 224, a spacer 228, and a filter 226. The lens 221, the aperture plates 224, the lens 222, the spacer 228, and the filter 226 are all received in the barrel 220 in this order from an object side to an image side. The barrel 220 is coupled with the holder 229 using threads.

The image sensor 30 can be a charge-coupled device (CCD) or a complementary metal oxide semiconductor (CMOS) device.

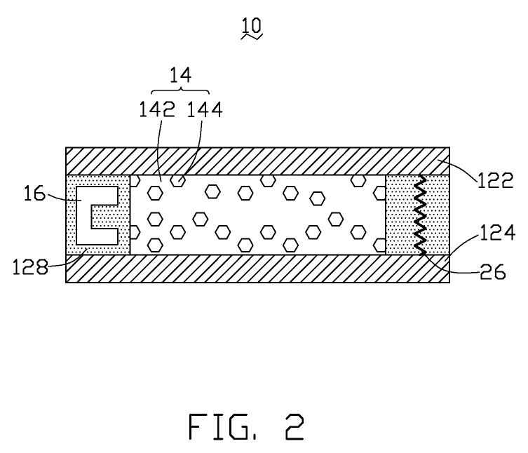

Referring to FIG. 2, the shutter 10 according to a first embodiment includes an upper plate 122, a lower plate 124 facing the upper plate 122, and a cylindrical side plate 126, a magnetic fluid 14, a magnetic field generator 16, and a heater 26. The side plate 126 is connected between the upper plate 122 and the lower plate 124. The upper plate 122, the lower plate 124, and the side plate 128 cooperatively define a cylindrical chamber (not labeled) for receiving the magnetic fluid 14 therein. The upper plate 122 and the lower plate 124 are transparent and the side plate 128 can be opaque.

The magnetic fluid 14 includes a solution 142, a plurality of magnetic particles 144 dispersed therein, and a surfactant (not shown). The solution 142 is transparent. The solution 142 can be selected from the group consisting of water solution, alcohol solution, methanol solution, hexamethylene solution, and normal octane solution. The particles 144 are black. A material of the particles 144 can be selected from the group consisting of ferrosoferric oxide and manganese zinc ferrite. Diameters of the particles 144 are in an approximate range from 1 namometers (nm) to 100 nm, and are preferably in an approximate range from 15 nm to 25 nm. A weight ratio of the particles 144 in the fluid 14 can be in an approximate range from 0.01% to 20%. Each of the particles 144 is totally surrounded by the surfactant so that the magnetic particles 144 can be dispersed spatially evenly in the solution 142 when no magnetic field exists. In this case, the shutter 10 is in an initial state. A material of the surfactant can be selected from the group consisting of polyvinyl alcohol, oleic acid, linoleic acid, and olive oil.

The generator 16 is received in the side plate 128 and is configured for controlling a distribution of the particles 144 through generation of a magnetic field or not. The generator 16 can be an electromagnet. The heater 26 can be received in the side plate 128 facing the generator 16, and is configured for heating the magnetic fluid 14 so that the shutter 100 returns to the initial state more quickly. The heater 26 can be a resistance heater.

The way in which the imaging system 100 works will be described in detail as follows. Before taking photographs, the particles 144 are distributed spatially evenly in the solution 142 in an initial state, referring to FIGS. 1 and 2. The particles 144 are black, thus blocking light from the upper plate 122. Therefore, the light cannot reach the image sensor 30.

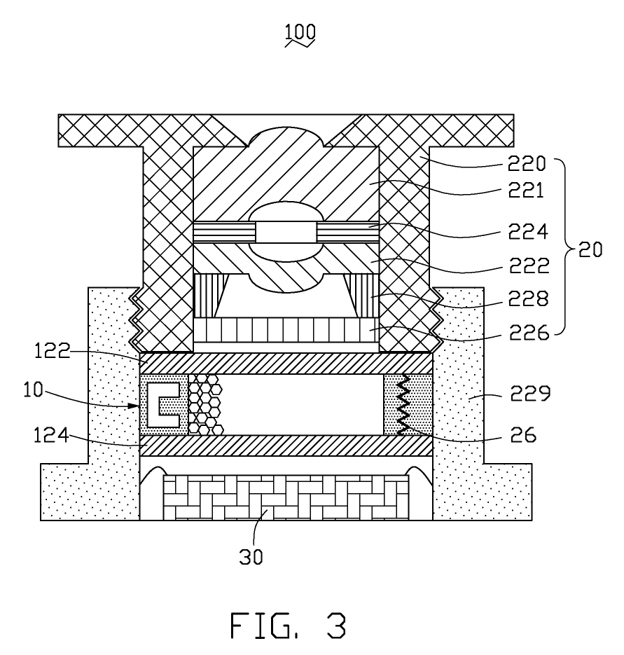

Referring to FIG. 3, when taking a photograph a voltage is fed into the generator 16, and then the generator 16 generates a magnetic field. Accordingly, the particles 144 are attracted to one end of the chamber close to the generator 16. Therefore, light from the upper plate 122 passes through the lower plate 124, and then reaches the image sensor 30.

Referring to FIG. 1 again, when no voltage is applied on the generator 16, no magnetic field exists and the shutter 100 returns to the initial state. In other words, the particles 144 are distributed spatially evenly in the solution 142. The particles 144 block light from the upper plate 122. Thus the light cannot reach the image sensor 30. In order to make the particles 144 return to the initial state more quickly, the heater 26 can heat the magnetic fluid 14.

The shutter 10 includes the magnetic fluid 14, and the magnetic field generator 16. The magnetic fluid 14 includes the solution 142 and the plurality of magnetic particles 144 dispersed therein. The generator 16 generates a magnetic field or not depending on whether a voltage is fed to the generator 16. As a result, the distribution of the particles 144 can be changed thus allowing light to pass through the shutter 14 or not. Therefore, the shutter 10 is simple, cheap, and quiet.

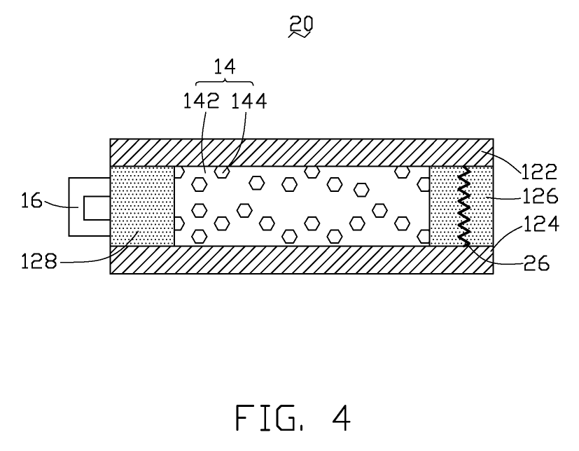

Referring to FIG. 4, a shutter 20 according to a second embodiment is shown. The shutter 20 is similar to the shutter 10, but the generator 16 is disposed outside the chamber and adjacent to the side plate 128.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A shutter comprising:
an upper plate;
a lower plate facing the upper plate;
a side plate connected between the upper plate and the lower plate, wherein the upper plate, the lower plate, and the side plate cooperatively define a chamber;
a magnetic fluid accommodated in the chamber, the fluid comprising a transparent solution, a surfactant, and a plurality of black magnetic particles dispersed in the solution and surrounded by the surfactant; and
a magnetic field generator positioned outside and adjacent to the chamber, wherein the generator is for generating a magnetic field in the chamber.

2. The shutter as claimed in claim 1, wherein the surfactant is selected from the group consisting of polyvinyl alcohol, oleic acid, linoleic acid, and olive oil.

3. The shutter as claimed in claim 1, wherein a material of the particles is selected from the group consisting of ferrosoferric oxide and manganese zinc ferrite.

4. The shutter as claimed in claim 1, wherein a diameter of each of the particles is in an approximate range from 1 nm to 100 nm.

5. The shutter as claimed in claim 5, wherein a diameter of each of the particles is in an approximate range from 15 nm to 25 nm.

6. The shutter as claimed in claim 1, wherein a percentage by weight of the particles in the fluid is in an approximate range from 0.01% to 20%.

7. The shutter as claimed in claim 1, wherein the solution is selected from the group consisting of water solution, alcohol solution, methanol solution, hexamethylene solution, and normal octane solution.

8. The shutter as claimed in claim 1, wherein the generator includes an electromagnet.

9. The shutter as claimed in claim 1, further comprising a heater disposed in the side plate.

10. The shutter as claimed in claim 9, wherein the heater includes a resistor.

11. The shutter as claimed in claim 1, wherein the magnetic generator is disposed in the side plate.

12. The shutter as claimed in claim 1, wherein the magnetic generator is disposed adjacent to the side plate.

13. An imaging system, comprising:
a holder;
a barrel coupled with the holder;
at least one lens received in the barrel;
an image sensor disposed in the holder; and
a shutter being disposed in the holder and positioned between the barrel and the image sensor, wherein the shutter comprising:
an upper plate;
a lower plate facing the upper plate;
a side plate connected between the upper plate and the lower plate, wherein the upper plate, the lower plate, and the side plate cooperatively define a chamber;
a magnetic fluid accommodated in the chamber, the fluid comprising a transparent solution, a surfactant, and a plurality of black magnetic particles dispersed in the solution and surrounded by the surfactant; and
a magnetic field generator positioned outside and adjacent to the chamber, wherein the generator is for generating a magnetic field in the chamber.

14. The imaging system as claimed in claim 13, wherein the surfactant is selected from the group consisting of polyvinyl alcohol, oleic acid, linoleic acid, and olive oil.

15. The imaging system as claimed in claim 13, wherein a material of the particles is selected from the group consisting of ferrosoferric oxide and manganese zinc ferrite.

16. The imaging system as claimed in claim 13, wherein a percentage by weight of the particles in the fluid is in an approximate range from 0.01% to 20%.

17. The imaging system as claimed in claim 13, wherein the shutter further comprises a heater disposed in the side plate.
